(19) United States
(12) Patent Application Publication
(10) Pub. No.: US 2008/0032608 A1
(43) Pub. Date: Feb. 7, 2008

(54) Process for Manufacturing Glass Substrate for Magnetic Recording Medium and Glass Substrate for Magnetic Recording Medium Obtained by the Process

(75) Inventors: Katsuaki Aida, Chiba (JP); Hiroyuki Machida, Chiba (JP); Kazuyuki Haneda, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Tokyo (JP)

(21) Appl. No.: 11/660,743

(22) PCT Filed: Aug. 4, 2005
(86) PCT No.: PCT/JP05/14703

§ 371 Date: Feb. 22, 2007

Related U.S. Application Data
(60) Provisional application No. 60/606,438, filed on Sep. 2, 2004.

(30) Foreign Application Priority Data
Aug. 27, 2004 (JP) 2004-248068

(51) Int. Cl. C03C 15/00; C03C 19/00; C03C 23/00; G11B 5/73; G11B 5/84

(52) U.S. Cl. 451/41

(57) ABSTRACT

A process for manufacturing a glass substrate for a magnetic recording medium, comprising polishing a glass substrate is polished using abrasive grains and then washing the substrate using a 0.02-0.3% aqueous hydrofluoric acid solution, and a glass substrate for a magnetic recording medium which is manufactured by the process. A polished glass substrate for a magnetic recording medium is manufactured, whereby during washing after polishing of the glass substrate, manifestation of substrate surface defects and overall waviness of the substrate can be minimized, and whereby texture formation in the subsequent texturing step can be accomplished in a uniform manner without creating variation between substrates.

### CROSS-REFERENCE TO RELATED APPLICATION

This application is an application filed under 35 U.S.C. § 111(a) claiming benefit of priority pursuant to 35 U.S.C. § 119(e)(1) of the filing date of the Provisional Application 60/606,438 filed Sep. 2, 2004, pursuant to 35 U.S.C. § 111(b).

### TECHNICAL FIELD

The present invention relates to a process for manufacturing a glass substrate for a magnetic recording medium, and to a glass substrate for a magnetic recording medium which is obtained by the process. More specifically, the invention relates to a process for manufacturing a glass substrate for a magnetic recording medium wherein a glass substrate is polished and then washed prior to texturing treatment, as well as to a glass substrate for a magnetic recording medium which is obtained by the process.

### BACKGROUND ART

Glass substrates used for magnetic recording media such as hard disks must have a high degree of flatness and smoothness. Glass substrates are therefore subjected to a step for surface polishing and a subsequent step for washing. The glass substrates for magnetic recording media which are obtained by such processes are also subjected to a texturing step for surface treatment.

Efficient polishing of glass substrate surfaces is accomplished by using abrasive grains such as of cerium oxide or zirconium oxide as a polishing agent, but a problem is encountered when such abrasive grains adhere to the glass surface. As a result, it is necessary to remove the adhering abrasive grains and glass shavings produced during the polishing step by washing prior to the texturing step.

For amorphous glass substrates, inorganic acids or organic acids are commonly used for washing after polishing (for example, see Japanese Unexamined Patent Publication No. 2003-212603), but conventional washing methods result in formation of a non-uniform texture in the subsequent texturing step, thereby producing variation between substrates, creating manifest defects in the substrate surface or creating overall waviness in the substrate, and therefore washing methods which avoid these problems have been desired.

On the other hand, treatment of polished glass substrates with aqueous hydrofluoric acid solutions is known (see Japanese Unexamined Patent Publication No. 2000-302482), but the purpose of such treatment is removal of the surface layer of the glass substrate by etching with the aqueous hydrofluoric acid solution, and therefore aqueous hydrofluoric acid solutions having a high concentration of 0.5% or greater are used for etching of the glass surface layer.

### DISCLOSURE OF INVENTION

It is an object of the present invention to provide a process for manufacturing a polished glass substrate for a magnetic recording medium, whereby during washing after polishing of the glass substrate, manifestation of substrate surface defects and overall waviness of the substrate can be minimized, and whereby texture formation in the subsequent texturing step can be accomplished in a uniform manner without creating variation between substrates; it is another object to provide a glass substrate for a magnetic recording medium exhibiting excellent characteristics, which is obtained by the aforementioned process.

As a result of much diligent research in light of the circumstances of the prior art described above, the present inventors discovered that the aforementioned problem can be overcome by using a low-concentration aqueous hydrofluoric acid solution for washing treatment of polished glass substrates.

The present invention therefore comprises the following aspects.

[1] A process for manufacturing a glass substrate for a magnetic recording medium, comprising polishing a glass substrate is polished using abrasive grains and then washing the substrate using a 0.02-0.3% aqueous hydrofluoric acid solution.

[2] A process for manufacturing a glass substrate for a magnetic recording medium according to [1] above, wherein the glass substrate is a substrate composed of amorphous glass.

[3] A process for manufacturing a glass substrate for a magnetic recording medium according to [1] or [2] above, wherein the concentration of the aqueous hydrofluoric acid solution is 0.04-0.15%.

[4] A process for manufacturing a glass substrate for a magnetic recording medium according to any one of [1] to [3] above, wherein the washing is carried out at a temperature of 10-70° C.

[5] A glass substrate for a magnetic recording medium manufactured by a process according to any one of [1] to [4] above.

[6] A magnetic recording medium manufactured using a glass substrate for a magnetic recording medium according to [5] above.

According to the invention, it is possible to provide glass substrates for magnetic recording media which have no surface defects or overall waviness, and which allow texture to be formed in the subsequent texturing step in a uniform manner without creating variation between substrates.

### BEST MODE FOR CARRYING OUT THE INVENTION

A preferred embodiment of the invention will now be described. However, the following explanation focuses specifically on a preferred example of carrying out the invention and is not intended to place any restrictions whatsoever on the scope of the invention.

According to the invention, the glass substrate is preferably sheet-like glass composed of amorphous glass having a basic composition of aluminosilicate.

Abrasive grains such as of cerium oxide, zirconium oxide, aluminum oxide, silicon oxide or the like may be used as the polishing agent for polishing of the glass substrate surface. Among these, abrasive grains composed of cerium oxide are preferred from the viewpoint of polishing efficiency. The polishing agent may be used as a suspension of the abrasive grains in water.

The polished glass substrate is then subjected to a washing step. According to the invention, the washing is carried out using an aqueous hydrofluoric acid solution with a concentration of 0.02-0.3% (mass %, hereinafter indicated only by “%”). The hydrofluoric acid concentration of the aqueous hydrofluoric acid solution is preferably no greater than 0.15% and more preferably 0.04-0.15%. The washing with the aqueous hydrofluoric acid solution will generally involve dipping of the glass substrate in the aqueous hydrofluoric acid solution. In this case, the dipping temperature is preferably 10-70° C., more preferably 15-60° C., even more preferably 25-50° C. and most preferably about 40° C., and the dipping time is preferably 1-3 minutes and most preferably about 2 minutes.

According to the invention, the glass substrate is preferably subjected to mechanical washing such as ordinary brush scrubbing prior to washing with the aqueous hydrofluoric acid solution.

This process yields a glass substrate for a magnetic recording medium, but for later manufacturing a magnetic recording medium, the glass substrate for a magnetic recording medium is subsequently subjected first to a texturing step and then to a step of forming a magnetic film on the surface by an ordinary procedure, finally yielding a magnetic recording medium. Furthermore, the washing treatment described above results in excellent advantages of the resulting glass substrate for a magnetic recording medium, in that it minimizes manifestation of defects in the substrate surface and overall waviness of the substrate, while allowing texture to be formed in the subsequent texturing step in a uniform manner without creating variation between substrates.

The present invention will now be explained in greater detail through the following example.

Substrate for magnetic recording media were manufactured using amorphous glass having a 90% by mass predominant component composition of B₂O₃+Al₂O₃+SiO₂ and a 7% by mass remaining composition of Li₂O+Na₂O+K₂O.

First, the raw material glass having the aforementioned composition was melted and press molded to obtain a disk-shaped glass sheet. A hole was formed in the glass sheet using a drill. Next, the main surface of each panel was subjected to two-stage lapping process comprising loose lapping and tight lapping, for adjustment of the panel thickness. The inner edge of the hole and the outer peripheral edge of the panel were each subjected to chamfering to form chamfered edges.

After polishing the inner edge of the hole and the outer peripheral edge of the processed glass substrate to a mirror surface, the main surface of the panel was also polished to a final mirror surface. The polishing agent used was a cerium oxide powder-containing polishing agent (MIREK by Mitsui Kinzoku Co., Ltd.).

Each of the obtained panels was then washed by brush scrubbing and then washed by dipping in an aqueous hydrofluoric acid solution for removal of the surface residue to obtain a glass substrate for a magnetic recording medium.

The hydrofluoric acid concentration (wt %) for dip washing was changed as shown in Table 1 below, and the surface roughness, overall waviness and surface defects of the substrates were evaluated. The dipping temperature was approximately 40° C. and the dipping time was approximately 2 minutes.

The surface roughness (Ra) was evaluated in a 10 μm field using an AFM (Atomic Microscope) by Digital Instruments. The waviness (Wa) was evaluated as the waviness in a wavelength range with a frequency component of up to 5 mm, using an Opti-flat interferometer by Phase Shift Corp. The surface defects were evaluated in a 10 nm slice using an RZ3500 ODT (Optical Defect Tester) by Hitachi Hightechnology.

Next, each obtained substrate was subjected to texturing treatment using a diamond slurry, and was then mounted in a sputtering apparatus for sputtering to form a base film composed of a chromium alloy and a magnetic film composed of a cobalt alloy, after which a diamond-like carbon film was formed thereover by CVD and the film was coated with Fonblin Z-Tetraol (Solvay Solexis) as a lubricant to manufacture a magnetic recording medium. The total thickness of the film formed by sputtering was 90 nm, and the thickness of the film formed by CVD was 10 nm. Twenty-five such magnetic recording media were manufactured in this manner.

The texture uniformity of each of the magnetic recording media was evaluated by visual inspection under a 100,000 lux condensed beam lamp in a dark room, and the media yield was evaluated by glide (BG) and error testing (ER). The evaluation was carried out under conditions allowing evaluation of media with a 40 GB recording capacity on a single 65 mm-diameter disk.

TABLE 1

| | Substrate evaluation | | | | | Media evaluation | | |
|---|---|---|---|---|---|---|---|---|
| | HF | Substrate | | | | | Yield | |
| | concentration | roughness | Waviness | ODT | | | evaluation | |
| No. | (wt %) | Ra(Å) | Wa(Å) | P | N | TEX uniformity | BG | ER |
| 1 | 0 | 2.8 | 3.8 | 8.7 | 6.5 | Variation | 96% | 80% |
| 2 | 0.005 | 3.3 | 3.3 | 4.8 | 3.8 | Slight variation, but less than REF | | |
| 3 | 0.01 | 3.0 | 3.4 | 3.8 | 2.8 | Slight variation, but less than REF | | |
| 4 | 0.02 | 2.7 | 3.3 | 3.7 | 3.7 | Better than Nos. 2, 3 but variation present | | |
| 5 | 0.03 | 3.0 | 3.5 | 3.5 | 4.5 | Better than Nos. 2, 3 but variation present | | |
| 6 | 0.04 | 3.3 | 3.4 | 4.0 | 3.7 | No variation | | |
| 7 | 0.05 | 3.6 | 3.5 | 3.7 | 3.3 | No variation | 96% | 70% |
| 8 | 0.15 | 4.1 | 3.6 | 3.7 | 1.7 | No variation | 100% | 83% |
| 9 | 0.30 | 4.5 | 4.2 | 3.5 | 4.2 | No variation | 92% | 35% |
| 10 | 0.50 | 4.9 | 4.6 | 4.8 | 6.3 | No variation/numerous white spots | 50% | 0% |

### INDUSTRIAL APPLICABILITY

The present invention provides glass substrates for magnetic recording media which exhibit no surface defects or overall waviness while allowing uniform texture formation in the subsequent texturing step and creating no variation between substrates, and it may therefore be advantageously applied for manufacturing magnetic recording media.

1. A process for manufacturing a glass substrate for a magnetic recording medium, comprising polishing a glass substrate is polished using abrasive grains and then washing the substrate using a 0.02-0.3% aqueous hydrofluoric acid solution.

2. A process for manufacturing a glass substrate for a magnetic recording medium according to claim 1, wherein the glass substrate is a substrate composed of amorphous glass.

3. A process for manufacturing a glass substrate for a magnetic recording medium according to claim 1, wherein the concentration of the aqueous hydrofluoric acid solution is 0.04-0.15%.

4. A process for manufacturing a glass substrate for a magnetic recording medium according to claim 1, wherein the washing is carried out at a temperature of 10-70° C.

5. A glass substrate for a magnetic recording medium manufactured by a process according to claim 1.

6. A magnetic recording medium manufactured using a glass substrate for a magnetic recording medium according to claim 5.
